(19) United States
(12) Patent Application Publication
(10) Pub. No.: US 2024/0053602 A1
(43) Pub. Date: Feb. 15, 2024

(54) MEMS-BASED MODULATION AND BEAM CONTROL SYSTEMS AND METHODS

(71) Applicant: Teledyne Micralyne Inc., Edmonton (CA)

(72) Inventors: Glen Fitzpatrick, Edmonton (CA); Mary Seto, Edmonton (CA)

(21) Appl. No.: 18/494,673

(22) Filed: Oct. 25, 2023

Related U.S. Application Data
(63) Continuation of application No. PCT/US2022/028344, filed on May 9, 2022.
(60) Provisional application No. 63/189,325, filed on May 17, 2021.

(51) Int. Cl. G02B 26/08; G01S 7/481; G02B 26/10

(52) U.S. Cl. CPC G02B 26/0841; G01S 7/4817; G02B 26/105

(57) ABSTRACT

MEMs-based variable blazed gratings are provided for passive or active phase modulation and beam control in LIDAR among other applications. A system and method for modulating light uses a microelectromechanical structure having deformable diffractive elements. The light is directed to the diffractive elements which act to reflect the light as planar mirrors. Applying a predetermined electrostatic force corresponding to each diffractive element flexes each diffractive element independently from other diffractive elements. Each diffractive element is either flexed continuously through a range of deflected positions or held stably at a single deflected position to interfere with the light through phase changes imparted according to the laws of diffraction.

### CROSS-REFERENCE TO RELATED APPLICATIONS

This application is a continuation of International Patent Application No. PCT/US2022/028344 filed May 9, 2022 and entitled “MEMS-BASED MODULATION AND BEAM CONTROL SYSTEMS AND METHODS,” which claims priority to U.S. Provisional Patent Application No. 63/189,325 filed on May 17, 2021 and entitled “MEMS-BASED VARIABLE BLAZED GRATINGS FOR PASSIVE OR ACTIVE PHASE MODULATION AND BEAM CONTROL,” all of which are incorporated herein by reference in their entirety.

### TECHNICAL FIELD

One or more embodiments relate generally to uses of micro-electromechanical structures for various light-based applications, and in particular, for example, to micro-electromechanical structures-based modulation and beam control systems and methods.

### BACKGROUND

Light detection and ranging (“LIDAR”) is a method that detects a target within a field of view and calculates the distance to the target by emitting optical laser light in pulses and recording the precise time of pulse return. The reflection of each pulse is detected by a light detector and the precise time is recorded. The delay between the emitted light and returned light is used to calculate the distance from the target and is called Time of Flight (“TOF”) measurement. With enough information from scanning a beam or beams, object movement and shape can be determined. In this manner, LIDAR has been extensively used for atmospheric research, meteorology, geomorphology, surveying, mapping, spaceflight, military operations, autonomous vehicles, agriculture, forestry, archaeology, and other applications.

In a conventional LIDAR system, an exemplary architecture may include one or more stationary or moving lasers, scanner and optics including scanning or rotating mirrors, photodetector, receiver electronics, and navigation and positioning systems. However, such numerous components render the LIDAR system bulky and costly to manufacture and maintain. In order to reduce the size and costs of conventional LIDAR systems, the use of micro-electromechanical systems (“MEMS”) for optical beam steering has potential. MEMs refer to process technologies used to create integrated devices or systems which combine mechanical and electrical components. They are typically fabricated using integrated circuit processing techniques and can range in size from a few micrometers to millimeters.

First generation MEMS devices consist of silicon based scanning mirrors to replace laser movement, but their operation at their relatively low resonant frequency precludes pointing at an object of interest. They are thus considered to constitute a “passive” system. A more desirable system for monitoring a rapidly changing situation would be considered “active”, where the subtended angle of interest can be scanned as if by a scanning mirror, but then held at an angle to study an object of interest and evaluate the distance and movement through the time of flight information before resuming full field scanning again. The analogous situation of Radar saw the replacement of rotating dishes with initially passive Phased Array Radar, and subsequently active Phased Array Radar.

Conventional structured light applications may also benefit from the use of small, rugged and high speed MEMs devices. A structured light process projects different known optical light patterns onto a scene and captures the light from the scene by synchronizing the light and camera systems. The system uses the information about how the patterns appear after being distorted by the scene to interpret the three dimensional geometry. For the sake of simplicity, the ability to make structured light with a diffractive modulator involves having a plurality of moving beams of light, so from here on, beam steering can refer to a subsection of a single beam of steered light for a structured light application.

Considerable effort has been invested in the development of diffractive MEMs structures, particularly as light valves; however, a number of limitations remain in respect of MEMs structures. Deformable ribbon devices of the type described in U.S. Pat. No. 8,970,827 to Bloom have a ribbon attached to fixtures at its ends over a substrate. When voltage is applied to between the ribbon and the substrate, the voltage pulls the ribbon from its rest position into a downward U-shaped curve toward the substrate. By using a plurality of these ribbons, and actuating the ribbons in a variable range of actuation depths, a linear phase gradient can be imparted to the incoming beam, and thus the beam angle will sweep from the zero order to the positive and negative first orders. In this way, a passive scanning system which is more robust than a geometric scanning mirror can be made, and can attain much higher scanning rates than are possible with a larger MEMS scanning mirror system.

The resonant speed of ribbon oscillation depends on the inverse of the length of the ribbon. A long ribbon is desired for optical throughput, say in the case of using a lower brightness source such as an LED for cost reasons, but a short ribbon will provide faster oscillation speeds. This complication also makes it more difficult to design a system which offers the symmetry of balancing the spring restoring force to raise the ribbon from an actuated state to the rest position with the force required to actuate the ribbon from the rest position. The ribbon's natural frequency may be improved by making the ribbon shorter, but this makes the device more sensitive to the alignment of the incident light, and provides less total light throughput and requires increasingly higher voltage to actuate. Alternately, the ribbon may consist of many shorter ribbons in a row as in U.S. Pat. No. 8,947,509 to Bloom et al., but sacrifices optical efficiency for the sake of speed. The ability to balance the speed of actuation with the speed of mechanical restoration is important in an analogue operation in a cyclic mode, than in a switching operation, as optical aberrations can manifest through this imbalance of ribbon position control between electrostatic actuation and back again.

In Bloom and other devices using ribbon structures to form binary grating structures, the ribbon is pulled down with the classic ⅓ travel rule. After the ribbon is pulled down ⅓ of the travel, it snaps down as the electric field attraction overcomes the restoring force. As such, in order to have an analogue range of control over the entire ¼ wavelength of travel, the gap must be three times larger than for a digital on/off application for the same wavelength. This necessitates higher voltage requirements and potentially an even longer span if the stress of full actuation deflection is too high. Large deflection ribbon designs require extra design contingencies, as seen for example, with a Polychromator from Polychromix, designed as a switch or a spectrometer, but which are capable also of beam steering. The ribbon length requirements for large deflection ribbons coupled with the speed relationship to ribbon length makes fabricating a beamsteering ribbon grating with full analogue control difficult to achieve without sacrificing operational speed.

Ribbon based binary gratings provide both positive and negative orders when diffracting, which is not an issue when utilized as a switch to turn the zero order on and off, as the other orders are rejected. However, as a method to manipulate a beam, a blazed grating is more efficient. Efforts to create a blazed grating from a ribbon-based architecture require compromises. Using mechanical stops, the ribbon can tilt on touchdown actuation to blaze a single first order, but the analogue range would have variable blazing as the ribbon twists. There have been approximations made of a blaze angle by forming the ribbons into a staircase, but this is less efficient and is difficult to implement in a dynamic beam steering application.

### SUMMARY

One or more embodiments relate generally to uses of micro-electromechanical structures for various light-based applications, and in particular, micro-electromechanical structures-based variable blazed gratings (e.g., tilting mirror arrays and/or elements which act to reflect the light as planar mirrors) for passive or active phase modulation and beam control in light detection, ranging, and other applications.

In accordance with one or more embodiments, a method for modulating one or more beams of light using a microelectromechanical structure,
the micromechanical structure comprising a plurality of electrostatically deformable diffractive elements, each diffractive element comprising a pedestal and a flexible reflective member; the reflective member having an elongated shape of a long dimension and a short dimension, and comprising a supported part and at least one unsupported part; and the substrate supporting one or more bottom electrodes or serving as a bottom electrode;
the method comprising directing the light to the diffractive elements, wherein the diffractive elements act to reflect the light as planar mirrors; and applying a predetermined electrostatic force corresponding to each diffractive element so as to flex each diffractive element independently from other diffractive elements;
wherein each diffractive element is either flexed continuously through a range of deflected positions or held stably at a single deflected position to create the desired grating configuration.

In some embodiments, each diffractive element flexes about an axis parallel to the long dimension of each reflective member to vary a curvature of each reflective member to create the desired grating configuration.

In some embodiments, the diffractive elements are asymmetric having an inverted L-shaped cross section. In some embodiments, the diffractive elements are symmetric having a T-shaped cross section.

In some embodiments, the reflective member is in electrical contact with a source of control voltage. In some embodiments, the reflective member is held in a resting position when the control voltage is 0 V.

In some embodiments, the reflective member is movable continuously through the range of flexed positions in a predetermined pattern when the control voltage is greater than 0 V (either positive or negative between electrodes) and is applied incrementally, with each increment corresponding to each flexed position within the range.

In some embodiments, the reflective member is movable from the resting position to be held stably at a single position when the control voltage is greater than 0 V (either positive or negative between electrodes) and corresponds to the single position.

In accordance with one or more embodiments, a system for modulating one or more beams of light using a microelectromechanical structure,
the micromechanical structure comprising a plurality of electrostatically deformable diffractive elements, each diffractive element comprising a pedestal and a flexible reflective member; the reflective member having an elongated shape of a long dimension and a short dimension, and comprising a supported part and at least one unsupported part; and the substrate supporting one or more bottom electrodes or serving as a bottom electrode;
the diffractive elements being configured to reflect the light as planar mirrors; and to flex independently from other diffractive elements upon application of a predetermined electro static force corresponding to each diffractive element;
wherein each diffractive element is either flexed continuously through a range of deflected positions or held stably at a single deflected position to create the desired grating configuration.

In some embodiments, the reflective member comprises one or more layers of electrically conductive material, and one or more layers of additional material placed over the electrically conductive material for conferring one or more of an optical function and a structural function.

In some embodiments, the one or more layers comprise aluminum, gold, a refractory metal having a reflection enhancement coating, a material for enhancing optical reflectivity, or a combination thereof.

In some embodiments, the one or more bottom electrodes comprise one or more layers of electrically conductive material, and one or more layers of additional material placed over the electrically conductive material for conferring one or more of an optical function, a structural function, and an electrical function.

In some embodiments, the one or more layers comprise aluminum, enhanced reflectivity aluminum, silver, gold, a refractory metal, a doped semiconductor with a reflection altering coating, a dielectric barrier, or a combination thereof.

Additional aspects and advantages of the present disclosure will be apparent in view of the description, which follows. It should be understood, however, that the detailed description and the specific examples, while indicating various embodiments of the invention, are given by way of illustration only, since various changes and modifications within the spirit and scope of the invention will become apparent to those skilled in the art from this detailed description.

### BRIEF DESCRIPTION OF THE DRAWINGS

Embodiments of the present disclosure will now be described with reference to the accompanying simplified, diagrammatic, not-to-scale drawings. In the drawings:

FIG. 1A shows a prior art L-shaped diffractive element comprising an elongated ribbon having a supported portion on a pedestal and an unsupported portion, in a non-energized (unactuated) state.

FIG. 1B shows a prior art system comprising a plurality of the L-shaped diffractive elements of FIG. 1A, with the left set in the energized (diffracting) state and the right set in the non-energized (unactuated) state.

FIG. 2 is a scanning electron microscope (SEM) image of an L-shaped diffractive element in a non-energized (unactuated) state.

FIG. 3A shows a cross-sectional view of a portion of one embodiment of a system comprising a plurality of L-shaped diffractive elements in the non-energized (unactuated) state, with the total possible distance of travel for the wing of the ribbon represented as “h” and the analogue variable range of travel without experiencing full actuation or “snapdown” represented as “a”.

FIG. 3B shows a cross-sectional view of the L-shaped diffractive element of FIG. 3A in an energized (actuated) state, with the wing of the ribbon partially deflected towards the electrode or substrate.

FIG. 3C shows a cross-sectional view of the L-shaped diffractive element of FIG. 3B in an energized (actuated) state, with the wing of the ribbon being deflected further towards the electrode or substrate.

FIG. 3D shows a cross-sectional view of the L-shaped diffractive element of FIG. 3C in an energized (actuated) state, with the wing of the ribbon fully deflected towards the electrode or substrate.

FIG. 4 shows a cross-sectional view of one embodiment of a system comprising a set of adjacent L-shaped diffractive elements with varying deflection.

FIG. 5 shows the positions of a deliberately stress curled T-shaped ribbon controlled in single volt increments, each half representing the deflection of an inverse L-shaped ribbon. The transition between the upper analogue control range “a” and the snapdown state can be clearly seen, as well as the ability to hold any single deflection position.

FIG. 6 is a graph showing the response time of snapdown and snap up, illustrating the balanced electrical actuation and mechanical restoration forces which make a strobed signal more symmetrical in optical performance.

FIG. 7 shows a cross-sectional view of a prior art system comprising a plurality of T-shaped diffractive elements in a non-energized (unactuated) state and energized (actuated) state.

### DETAILED DESCRIPTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the embodiments will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the present disclosure. The upper and lower limits of these smaller ranges may independently be included in the smaller ranges and are also encompassed within the present disclosure, subject to any specifically excluded limit in the stated range. Where the stated range includes one or both of the limits, ranges excluding either or both of those included limits are also included in the present disclosure.

Unless defined otherwise, all technical and scientific terms used herein have the same meaning as commonly understood by one of ordinary skill in the art to which the present disclosure belongs. Although any methods and materials similar or equivalent to those described herein can also be used in the practice or testing of the present disclosure, a limited number of the exemplary methods and materials are described herein.

It must be noted that as used herein and in the appended claims, the singular forms “a,” “an,” and “the” include plural referents unless the context clearly dictates otherwise.

The present disclosure relates generally to uses of micro-electromechanical structures (“MEMs”) for various light-based applications, and in particular, uses of MEMs-based variable blazed gratings for passive or active phase modulation and beam control in light detection and ranging (“LIDAR”) and other applications. There is a need in the art for improved MEMs-based variable blazed gratings for use in LIDAR systems and structured light applications in order to not only provide high speed passive scanning, active scanning control, and a robust structure, but also have a large effective reflective area to allow significant signal strength. Blazing allows more efficient use of the light beam and the reduction of diffracted orders to manage.

In accordance with one or more embodiments, a method is provided for modulating one or more beams of light using a microelectromechanical structure,
the micromechanical structure comprising a plurality of electrostatically deformable diffractive elements, each diffractive element comprising a pedestal and a flexible reflective member; the reflective member having an elongated shape of a long dimension and a short dimension, and comprising a supported part and at least one unsupported part; and the substrate supporting one or more bottom electrodes or serving as a bottom electrode;
the method comprising directing the light to the diffractive elements, wherein the diffractive elements act to reflect the light as planar mirrors; and applying a predetermined electrostatic force corresponding to each diffractive element so as to flex each diffractive element independently from other diffractive elements;
wherein each diffractive element is either flexed continuously through a range of deflected positions or held stably at a single deflected position to create the desired grating configuration.

In accordance with one or more embodiments, a system is provided for modulating one or more beams of light using a microelectromechanical structure,
the micromechanical structure comprising a plurality of deformable electrostatically diffractive elements, each diffractive element comprising a pedestal and a flexible reflective member; the reflective member having an elongated shape of a long dimension and a short dimension, and comprising a supported part and at least one unsupported part; and the substrate supporting one or more bottom electrodes or serving as a bottom electrode;
the diffractive elements being configured to reflect the light as planar mirrors; and to flex independently from other diffractive elements upon application of a predetermined electrostatic force corresponding to each diffractive element;
wherein each diffractive element is either flexed continuously through a range of deflected positions or held stably at a single deflected position to create the desired grating configuration.

In the development of the present disclosure, it was found that MEMs-based structures comprising L-shaped or T-shaped diffractive elements may be suitable for use in accordance with one or more embodiments. The details for fabrication of MEMs-based structures are well known to those skilled in the art and described in detail for example, in U.S. Pat. No. 5,311,360 to Bloom et al. and U.S. Pat. No. 5,661,592 to Bornstein et al. Such methods may be adapted for fabrication of the MEMs-based structures of the present disclosure.

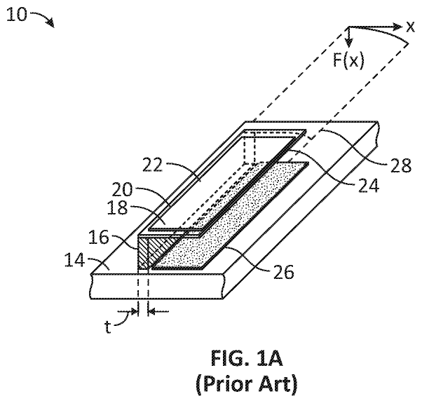

A representative L-shaped diffractive element is described for example, by Pilossof in U.S. Pat. No. 8,848,278, the disclosure of which is hereby incorporated by reference herein. Referring to FIG. 1A, a single L-shaped diffractive element (10) is shown for sake of clarity and simplicity. However, as shown in FIG. 1B, a device (12) may include multiple L-shaped diffractive elements (10) arranged to provide a linear array containing for example, hundreds to thousands of diffractive elements (10).

The L-shaped diffractive element (10) has an asymmetric cross section in the form of an inverse L-shape, and is fabricated on a silicon or similar substrate (14). The L-shaped diffractive element (10) comprises a pedestal (16) vertically supporting an elongate ribbon (18) along one side of its longitudinal axis. The ribbon (18) comprises an immovable, supported portion (20) anchored to the pedestal (16), a reflective mirror surface (22), and a movable, unsupported elongated portion laterally extending along the pedestal (16) which forms a single freely extending wing (24). The wing (24) functions with materials lending structural strength, dielectric properties to separate it from a bottom electrode (26) on the underside of the wing (24), and optical properties which could allow some structural components to be on the top surface to contribute to the reflectivity of the mirror surface (22), but will be shown as a simplified structure. The wing (24) has a length parallel to the pedestal (16) that is significantly greater than its width in a direction traverse to the pedestal (16). The wing (24) is elastically deformable in the direction of the arrows forming the F(x) shape based on the balance of the mechanical restoring force and the electrostatic force imposed in operation. F(x) may depend for example, on the dimensions of the ribbon (18), the mechanical properties (for example, thickness and strength) of the material forming the ribbon (18), and the applied voltage.

The reflective mirror surface (22) is provided on the upper surface of the ribbon (18), and may comprise one or more layers of an electrically conductive material including, but not limited to, aluminum, gold, refractory metals with reflection enhancement coatings, or other suitable materials for enhancing optical reflectivity. For clarity, the reflective mirror surface (22) is shown as a single layer. In some embodiments, the one or more layers of electrically conductive material confer functionality as a top electrode. In some embodiments, one or more additional layers of such materials may be added over the top electrode to confer desired optical and structural functions including, but not limited to, altering reflectivity.

In some embodiments, the substrate (14) may support one or more bottom electrodes (26) on its surface, or serve as a single bottom electrode. In such a configuration as a single bottom electrode, the substrate (14) may comprise for example, a doped silicon wafer.

In some embodiments, one or more bottom electrodes (26) are provided on the surface of the substrate (14) adjacent with the underside of the wing (24), and may comprise pads of a metal including, but not limited to, aluminum (or enhanced reflectivity aluminum), silver, gold, refractory metals, or doped semiconductors with reflection altering coatings and/or dielectric barriers. In some embodiments, one or more additional layers of such materials may be added over the bottom electrode to confer desired optical, structural, or electrical functions including, but not limited to, altering reflectivity while serving as functional mirror contact layers and dielectric insulator material.

FIG. 1A shows the L-shaped diffractive element (10) in its non-energized (unactuated) state. In the non-energized (unactuated) state, no voltage is applied between the top electrode (22) and bottom electrode (26) such that the diffractive element (10) assumes a “resting” position. In some embodiments, the resting position is relatively flat, wherein the wing (24) of the ribbon (18) is oriented substantially horizontal relative to the substrate (14).

The pedestal (16) acts like a hinge, requiring the immovable, supported portion (20) of the ribbon (18) to be flat, and the wing (24) of the ribbon (18) to be bendable. The pedestal (16) extends along the length of the ribbon (18) which is thereby anchored along its length and at its ends to facilitate the deflection of the ribbon (18) downward towards the bottom electrode (26) upon voltage application. The high speed of the device (12) may be achieved from the pinning of the ends of the ribbon (18) which keeps the ribbon taut (18) and confers high restoring force, with the anchoring of the ribbon (18) along its length on the pedestal (16) acting as a mechanical support conferring the ability to maintain a flat ribbon (18) in the non-energized (unactuated) state. As used herein, the term “restoring force” refers to a force exerted to move the ribbon (18) from its energized (actuated) state into its non-energized (unactuated) state.

In the energized (actuated) state, voltage is applied between the top electrode (22) and the bottom electrode (26) such that the diffractive element (10) assumes a “deflected” position. Applying voltage between the top electrode (22) and the bottom electrode (26) establishes an electrostatic field between the top electrode (22) and the bottom electrodes (26), resulting in an attractive force therebetween. The force pulls the wing (24) of the ribbon (18) towards the bottom electrode (26) beneath the wing (24) which bends along its shorter axis towards the bottom electrode (26) and assumes position (28).

FIG. 1B shows a device (12) including L-shaped diffractive elements (10) in the non-energized (unactuated) state and L-shaped diffractive elements (10) in the energized (actuated) state. A device (12) comprises a plurality of the L-shaped diffractive elements (10) of FIG. 1A arranged in parallel rows. The distance “d” (same as A in equation I) between the ribbons (118, 218) is the grating constant and determines the diffracting power of the device (12). The gap “g” is the distance between adjacent ribbons (118, 218). The ratio “d/g” is the fill factor and affects the overall efficiency of the device (12). The higher the fill factor, the higher the efficiency may be of the device (12). The first pixel element (30) comprising ribbons (118) is shown in the energized (actuated) state upon application of voltage “V”, while the second pixel (32) comprising ribbons (218) is in the non-energized (unactuated) state to which no voltage has been applied (“V”=0). Light (34a) falling at the non-energized (unactuated) state reflects in one direction (36) as a plane mirror, while light (34b) falling at the energized (actuated) state is directed in different directions (38) governed by the laws of diffraction.

In FIG. 1B, the ribbons (118) not deflecting have 0 V between the ribbons (118) and the electrode (26), while the ribbons (218) deflecting have voltage applied, causing snapdown and formation of a diffraction grating which is shown as propagating in different directions (38). In this configuration, the ribbons (118, 218) are all switched by the same voltage to achieve the same F(x) in order to digitally turn on and off. However, this method may not be suitable for applications where it may be desirable to vary the deflection of selected diffractive elements (10) through a range of positions, or hold the deflection of selected diffractive elements (10) in a stable manner at a desired position other than the resting and fully deflected positions.

The present disclosure relates to uses of MEMs-based variable blazed gratings for passive or active phase modulation and beam control in LIDAR and other applications. In some embodiments, a method is provided for varying or oscillating the deflection of selected electrostatically deformable diffractive elements (10) through a range of positions. In this configuration, the deflection of the diffractive elements (10) is varied through the range of positions in order to create phase shifts of each diffractive element (10). In some embodiments, the phase shifts of the diffractive elements (10) are used to steer an optical beam. As used herein, the term “optical beam” means a beam of light, the source preferably being from a laser or other suitable device such as an LED. In some embodiments, the light comprises electromagnetic radiation of any frequency selected from ultraviolet, visible, or infrared light. In some embodiments, the optical beam is modulated continuously by moving the diffractive elements (10) in a predetermined pattern in a “passive” scanning manner. In some embodiments, the predetermined pattern is a repeating pattern.

In some embodiments, a method is provided for holding the deflection of selected diffractive elements (10) in a stable manner at a desired position. In some embodiments, the desired position is a position other than the resting position or fully deflected position. In some embodiments, the desired position comprises one or more positions between the resting position or fully deflected position. In this configuration, the deflection of the diffractive elements (10) is held in a stable manner at the desired position or a sub-range of positions in order to actively scan a smaller subtended angle than the total range of scanning available.

In the development of the present disclosure, it was found that any desired deflection for a diffractive element (10) may be varied or oscillated through a range of positions or held in a stable manner at the desired position or a sub-range of positions within an actuating range of deflections with corresponding voltages as further described.

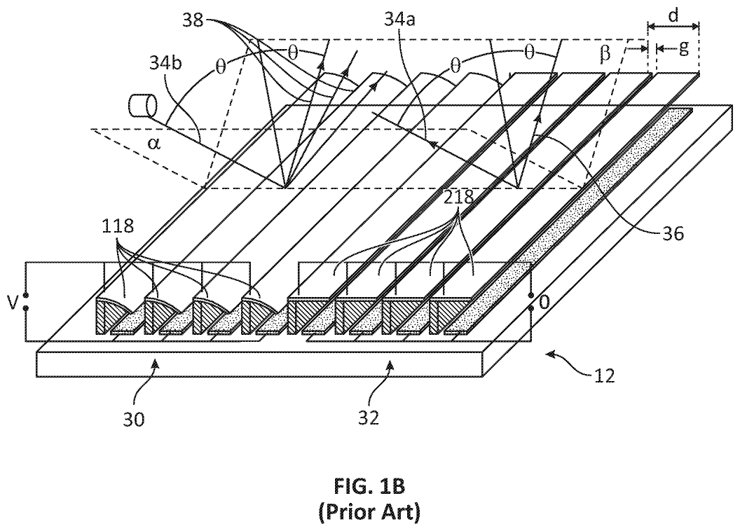

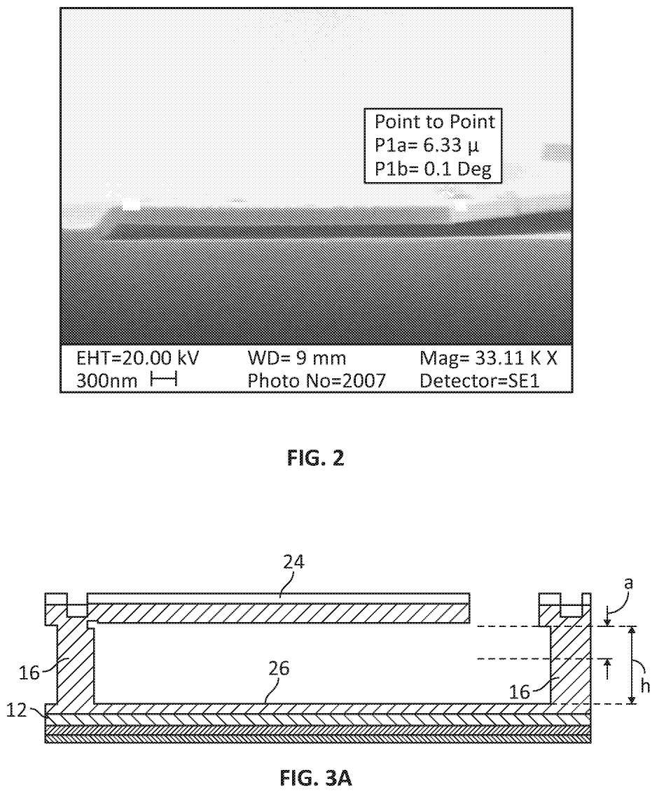

As shown in FIGS. 2 and 3A, the diffractive element (10) is in the non-energized (unactuated) state. In some embodiments, the resting position is relatively flat, wherein the wing (24) of the ribbon (18) is oriented substantially horizontal to the bottom electrode (26). In some embodiments, the resting position is curved, wherein the wing (24) of the ribbon (18) is oriented upward. The resting position may be varied depending on process determined stress to form the diffractive element (10) to suit the desired operation. The total distance or height through which the wing (24) of the ribbon (18) can travel is represented as “h”. The analogue variable range of travel without experiencing full actuation or “snapdown” is represented as “a”. This is dictated by the electrostatic laws which govern the attractive force balanced against the mechanical restoring force of the spring returning force of the ribbon (18).

FIG. 3B shows the diffractive element (10) in a “partially” energized state upon application of a corresponding voltage. The diffractive element (10) is deflected to an intermediate state between the non-energized (unactuated) state and the fully actuated “snapdown” state. The wing (24) of the ribbon (18) is thus deflected to a position between the resting position and the bottom electrode (26), with the deflected position (i.e., the plane of motion) being represented as “Δz” or distance from the resting position (FIG. 3C).

FIG. 3C shows the L-shaped diffractive element of FIG. 3B in an energized (actuated) state upon application of a corresponding voltage, with the wing (24) of the ribbon (18) being deflected further towards the bottom electrode (26).

FIG. 3D shows the diffractive element (10) in its fully actuated state, wherein the diffractive element (10) assumes a “tilting” architecture, with the wing (24) of the ribbon (18) positioned at the most extreme distance possible represented as “Δz” being equal to “h”. Under application of a corresponding voltage, the wing (24) of the ribbon (18) bends further toward the bottom electrode (26). As the voltage is further increased, a point is reached where the electrostatic force due to the applied voltage overcomes the restoring force due to the resilience of the ribbon (18). This results in snapdown, wherein the wing (24) of the ribbon (18) deforms until it touches the bottom electrode (26) or the substrate (12). When the voltage is released, the wing (24) of the ribbon (18) snaps back into shape (i.e., the resting position shown in FIG. 3A).

While a single L-shaped diffractive element (10) has been described above for sake of clarity and simplicity, the system according to one or more embodiments comprises a plurality of L-shaped diffractive elements (10) arranged to provide a linear array containing for example, hundreds to thousands of L-shaped diffractive elements (10). In this configuration, the ribbons (18) provide a reasonably large active optical area. In some embodiments, ribbons (18) having lengths of up to about 2 mm have been tested and proven to provide such a large active optical area (data not shown).

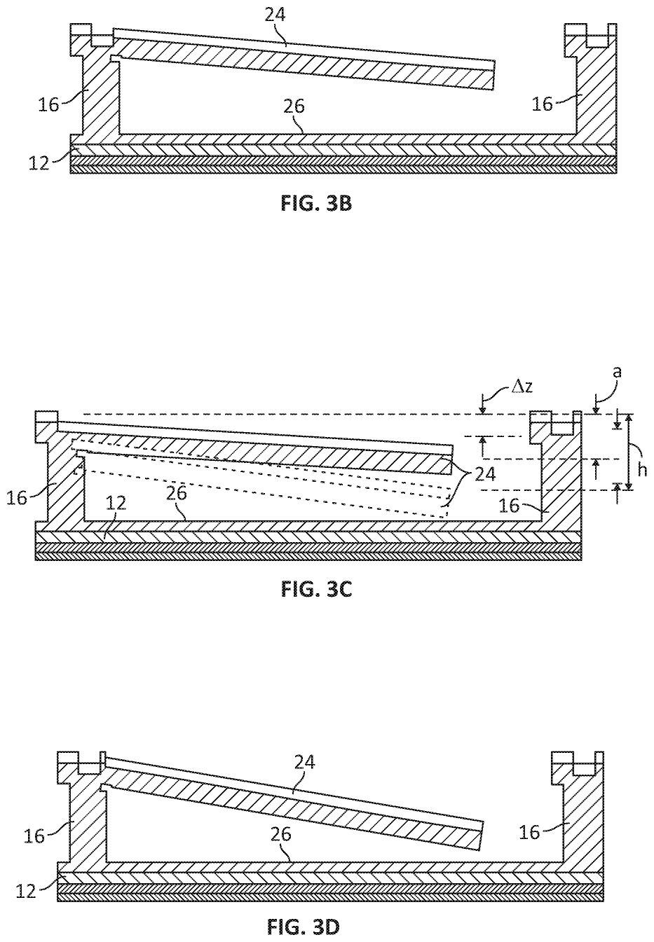

In some embodiments, the system comprises a plurality of adjacent L-shaped diffractive elements (10). FIG. 4 shows a set of adjacent L-shaped diffractive elements (10) with varying deflection. Each L-shaped diffractive element (10) is addressed individually with a different corresponding voltage applied to each L-shaped diffractive element (10). Each diffractive element (10) has its own F(x) based on the corresponding voltage applied, thereby exhibiting its own unique deflection. This configuration emulates a variable pitch blazed grating, thereby providing a phase adjustment pattern desired between a zero order reflection and the order diffracted by a fully actuated array.

The ribbon (18) is mechanically stiff with respect to deformations about its longitudinal axis. Without being bound to any theory, this may result in a high natural frequency of vibration (i.e., resonant frequency). In some embodiments, the high natural frequency is greater than about 500 KHz. In some embodiments, the high natural frequency is greater than about 1.0 MHz. In some embodiments, the high natural frequency is greater than about 10.0 MHz. Having a high natural frequency yields a rapid response time.

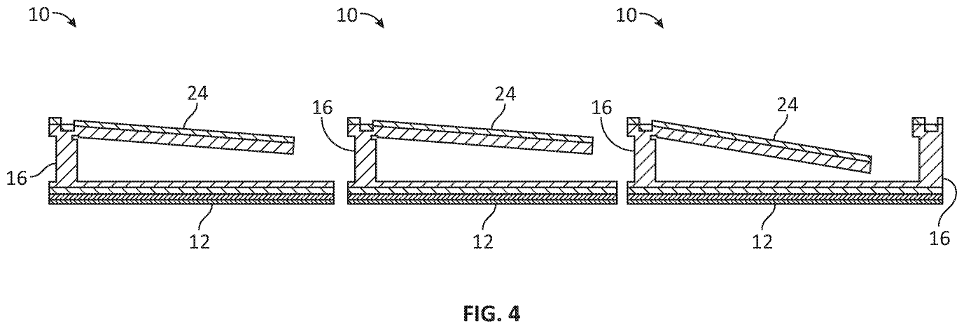

FIG. 5 shows various positions of a deliberately stress-curled ribbon controlled in single volt increments. An exemplary 1.4 MHz device was tuned for 830 nm wavelength with the same slope of actuation from flat time (i.e., the ribbon in the resting position) and the return from actuated back to the unactuated state. This device was made with a mask layout to provide varying lengths with the same width, “h” parameters, and materials of fabrication. The results are shown below in Table 1.

TABLE 1
Resonant Frequency versus Ribbon Length

| Length of Ribbon (μm) | Resonant Frequency (MHz) |
|---|---|
| 50 | 1.70 |
| 100 | 1.50 |
| 200 | 1.45 |
| 300 | 1.44 |
| 500 | 1.42 |
| 1000 | 1.41 |
| 2000 | 1.40 |

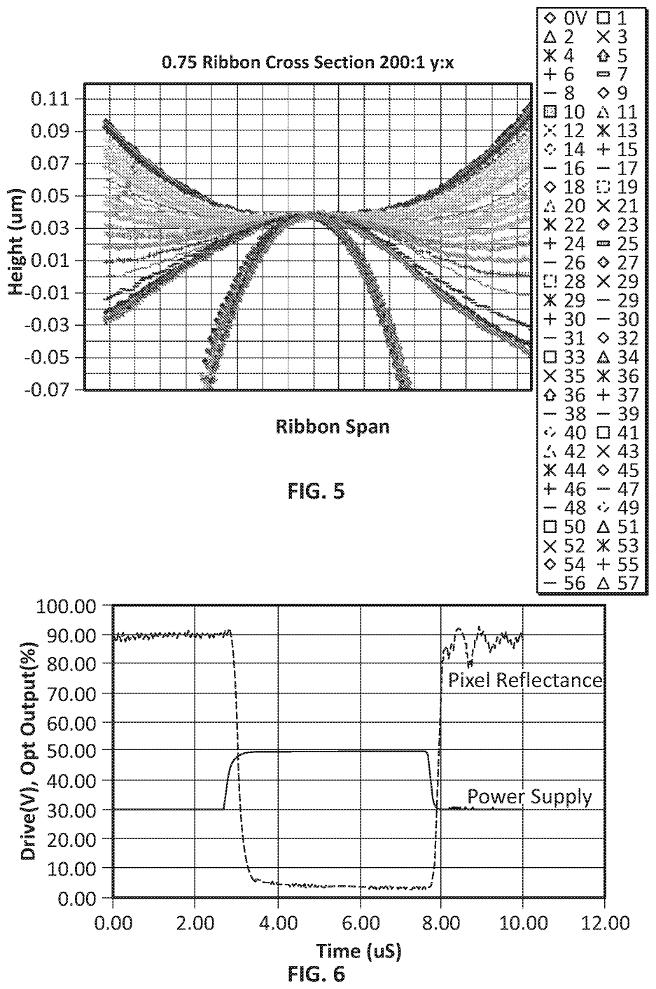

Without being bound by any theory, provision of consistent speed independent of ribbon length allows more variations for example including, but not limited to, a wedge-shaped array for two-dimensional layouts to diffract in more than one direction. FIG. 6 shows the response time of snapdown and snap up, illustrating the balanced electrical actuation and mechanical restoration forces which may make a strobed signal more symmetrical in optical performance. In other experiments, successful devices spanned “h” values from about 200 nm to about 5.6 microns.

As used herein, the term “optical beam steering” means passive or active steering of a beam of light over an angle θ, the maximum of which is determined by the wavelength λ of light used and the pitch of the smallest grating subdivision Λ as expressed in Equation (I):

θ=sin⁻¹(λ/2Λ) (I)

Accordingly, one skilled in the art may wish to use only the range of “a”, the analogue range, or the complete range “h” for the total “Δz” value. Similarly, the total “Δz” range may be ¼ λ to over 1λ to take advantage of the full 2π phase change.

In some embodiments, passive steering is conducted by oscillating the diffractive elements (10) at a frequency at or below resonance in a path which varies between deflection ranges, with the pitch being varied by the number of individual diffractive elements (10) approximating a grating. The pattern can be predetermined, and can be implemented by the MEMS chip to the limit of the drive electronics. In this configuration, one beam may be steered for LIDAR or a moving sweep of multiple beams may be created for structured light applications.

In some embodiments, active steering is conducted by deflecting the ribbon (18) to different points between un-actuated and fully actuated states. As used herein, the term “active” means that the beam of light is intentionally pointed towards one or more targets of interest which may be present within a field of view or by beamforming through interference at one beam angle. The high restoring force of the ribbon (18) allows a rapid recovery into a desired position from the fully actuated state, and the stability of the diffractive element (10) allows each ribbon (18) to hold a position of desired phase or deflection for a relatively large amount of time. In some embodiments, each ribbon position in FIG. 5 for each single volt increment took over about 100 seconds to acquire. The ability to hold one diffractive state on each ribbon (18) to form the desired beam structure desired is useful for applications including, but not limited to, an active scanning applications and laser tuning.

Accordingly, the present disclosure may be used for various applications including, but not limited to, beam steering and modulation (active or passive), structured light formation, spectroscopy, optical tweezers, quantum communication, diffractive approximations of Fresnel lens/mirror segments and laser tuning.

The above description refers to one embodiment of an L-shaped diffractive element for ease of explanation only and is not meant to be limiting. It should be understood by those skilled in the art that modified L-shaped and T-shaped diffractive elements may be equally well-suited for use in the present disclosure.

Representative modified L-shaped diffractive elements are described for example, by Fitzpatrick and Harley in U.S. patent application Ser. No. 16/985,110, the disclosure of which is hereby incorporated by reference herein. In some embodiments, a modified L-shaped diffractive element does not require an entire pedestal or consequently, an immovable, flat supported portion of the ribbon. The unsupported portion of the ribbon is “unhinged” and can remain relatively flat compared to the curve of the pedestal constrained portions as it bends freely towards the substrate upon electrostatic actuation. The ribbon thus has a pedestal support part which serves as the functional hinge and mechanical influence on the unsupported part which has no pedestal support and is thus unconstrained by the pedestal. The ribbon exhibits sufficient thickness to have speed from the restoring force, but also sufficient thinness to bend downwardly towards the substrate in a completely hinged system. This configuration may thus decouple the sufficient thinness required for bending downwardly (i.e., F(x) as straight as possible) from the sufficient thickness required for the restoring force.

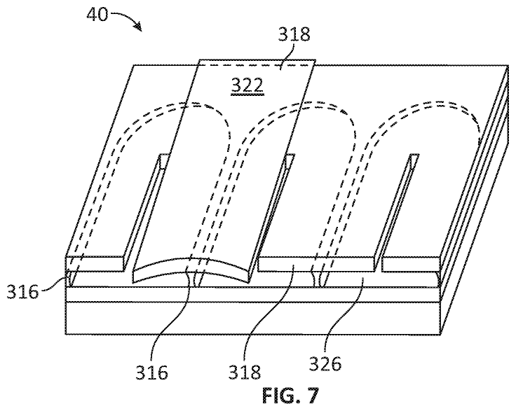

Representative T-shaped diffractive elements are described for example, by Fitzpatrick and Gelbart in U.S. Pat. Nos. 6,661,561; 6,836,352; and 6,856,448, the disclosures of which are hereby incorporated by reference herein. In some embodiments, the cross section of each diffractive element may be symmetrical in the form of a T-shape. As shown in FIG. 7, the T-shaped diffractive element (40) has a symmetric cross section. An elongated reflective ribbon (318) is mounted along its central long axis on a pedestal (316), and bends along its long axis to move from a non-energized (unactuated) T-shape to an energized (actuated) inverted V-shape. In the energized state, a sufficiently large voltage is applied between the electrodes (326) with the result that the ribbon (318) deforms in convex fashion with respect to an optical beam (not shown) and the light from the optical beam is diverged when it is reflected by the reflective mirror surface (322) of the ribbon (318).

It should be apparent, however, to those skilled in the art that many more modifications besides those already described are possible without departing from the inventive concepts herein. The inventive subject matter, therefore, is not to be restricted except in the scope of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. The references to the actuated structures as being diffractive elements does not exclude the geometric contributions of the actuated device shape to the resulting influence on light impinging on the device surface, but are referred to as such due to the size scale of the devices, which require taking the laws of diffraction into account.

1. A method for modulating one or more beams of light using a microelectromechanical structure,
the microelectromechanical structure comprising a plurality of electrostatically deformable diffractive elements, each diffractive element comprising a pedestal and a flexible reflective member; the reflective member having an elongated shape of a long dimension and a short dimension, the reflective member comprising a supported part and at least one unsupported part; and a substrate supporting one or more bottom electrodes or serving as a bottom electrode;
the method comprising directing the light to the diffractive elements, wherein the diffractive elements act to reflect the light as planar mirrors; and applying a predetermined electrostatic force corresponding to each diffractive element so as to flex each diffractive element independently from other diffractive elements;
wherein each diffractive element is either flexed continuously through a range of deflected positions or held stably at a single deflected position to create a desired grating configuration.

2. The method of claim 1, wherein each diffractive element flexes about an axis parallel to the long dimension of each reflective member to vary a curvature of each reflective member to create the desired grating configuration.

3. The method of claim 2, wherein the diffractive elements are asymmetric having an inverted L-shaped cross section, and wherein the applying comprises applying the predetermined electrostatic force corresponding to each diffractive element such that each diffractive element is held at a respective deflected position for a respective duration of time.

4. The method of claim 2, wherein the diffractive elements are symmetric having a T-shaped cross section, and wherein the applying comprises applying the same predetermined electrostatic force to each diffractive element.

5. The method of claim 2, wherein the reflective member is in electrical contact with a source of control voltage.

6. The method of claim 5, wherein the reflective member is held in a resting position when the control voltage is 0 V.

7. The method of claim 6, wherein the reflective member is movable continuously through a range of flexed positions in a predetermined pattern when the control voltage is greater than 0 V and is applied incrementally, with each increment corresponding to each flexed position within the range.

8. The method of claim 6, wherein the reflective member is movable from the resting position to be held stably at a single position when the control voltage is greater than 0 V and corresponds to the single position.

9. A system for modulating one or more beams of light using a microelectromechanical structure,
the microelectromechanical structure comprising a plurality of electrostatically deformable diffractive elements, each diffractive element comprising a pedestal and a flexible reflective member; the reflective member having an elongated shape of a long dimension and a short dimension, the reflective member comprising a supported part and at least one unsupported part; and a substrate supporting one or more bottom electrodes or serving as a bottom electrode;
the diffractive elements being configured to reflect the light as planar mirrors and to flex independently from other diffractive elements upon application of a predetermined electrostatic force corresponding to each diffractive element;
wherein each diffractive element is either flexed continuously through a range of deflected positions or held stably at a single deflected position to create a desired grating configuration.

10. The system of claim 9, wherein the diffractive elements are asymmetric having an inverted L-shaped cross section, wherein, in one configuration of the microelectromechanical structure, each of the diffractive elements is configured to receive the same predetermined electrostatic force and flex upon application of the same predetermined electrostatic force.

11. The system of claim 9, wherein the diffractive elements are symmetric having a T-shaped cross section.

12. The system of claim 9, wherein each diffractive element flexes about an axis parallel to the long dimension of each reflective member to vary a curvature of each reflective member to create the desired grating configuration.

13. The system of claim 9, wherein the reflective member is in electrical contact with a source of control voltage.

14. The system of claim 13, wherein the reflective member is configured to be held in a resting position when the control voltage is 0 V.

15. The system of claim 14, wherein the reflective member is configured to be movable continuously through a range of flexed positions in a predetermined pattern when the control voltage is greater than 0 V and applied incrementally, with each increment corresponding to each flexed position within the range.

16. The system of claim 14, wherein the reflective member is configured to be movable from the resting position to be held stably at a single position when the control voltage is greater than 0 V and corresponds to the single position.

17. The system of claim 9, wherein the reflective member comprises one or more layers of electrically conductive material, and one or more layers of additional material placed over the electrically conductive material for conferring one or more of an optical function or a structural function.

18. The system of claim 17, wherein the one or more layers comprise aluminum, gold, a refractory metal having a reflection enhancement coating, a material for enhancing optical reflectivity, or a combination thereof.

19. The system of claim 9, wherein the one or more bottom electrodes comprise one or more layers of electrically conductive material, and one or more layers of additional material placed over the electrically conductive material for conferring one or more of an optical function, a structural function, or an electrical function.

20. The system of claim 19, wherein the one or more layers comprise aluminum, enhanced reflectivity aluminum, silver, gold, a refractory metal, a doped semiconductor with a reflection altering coating, a dielectric barrier, or a combination thereof.
